(19) United States
(12) Patent Application Publication
(10) Pub. No.: US 2020/0278084 A1
(43) Pub. Date: Sep. 3, 2020

(54) GAS SUPPLY METHOD AND GAS SUPPLY SYSTEM

(71) Applicant: TOKYO ELECTRON LIMITED, Tokyo (JP)

(72) Inventors: Yukimasa SAITO, Nirasaki City (JP); Naohiro FURUYA, Nirasaki City (JP); Shinichi KAWAGUCHI, Nirasaki City (JP)

(21) Appl. No.: 16/803,467

(22) Filed: Feb. 27, 2020

(30) Foreign Application Priority Data
Feb. 28, 2019 (JP) 2019-035142

(51) Int. Cl. F17C 7/00; F17C 13/04

(52) U.S. Cl. CPC F17C 7/00; F17C 13/04; F17C 2270/0518; F17C 2223/0153; F17C 2227/039; F17C 2250/043; F17C 2250/0439; F17C 2227/0302; F17C 2227/044; F17C 2205/0338

(57) ABSTRACT

There is provide a gas supply method including: preparing a gas container filled with an easy-to-liquefy gas; and supplying the easy-to-liquefy gas from the gas container to a processing container in which a substrate process is performed using the easy-to-liquefy gas, via a gas supply path, wherein a pressure and a temperature of the easy-to-liquefy gas are controlled such that in the gas supply path, the pressure of the easy-to-liquefy gas decreases in a step-by-step manner and the temperature of the easy-to-liquefy gas increases from the gas container toward the processing container.

### CROSS-REFERENCE TO RELATED APPLICATION

This application is based upon and claims the benefit of priority from Japanese Patent Application No. 2019-035142, filed on Feb. 28, 2019, the entire contents of which are incorporated herein by reference.

### TECHNICAL FIELD

The present disclosure relates to a gas supply method and a gas supply system.

### BACKGROUND

In a process of manufacturing a semiconductor device, a process using an easy-to-liquefy gas such as an HF gas, a ClF₃ gas or the like may be performed. For example, Patent Documents 1 and 2 disclose technologies for performing a chemical oxide removal process (COR) that chemically removes a silicon oxide film with a hydrogen fluoride (HF) gas and an ammonia (NH₃) gas.

### PRIOR ART DOCUMENT

### Patent Documents

Patent Document 1: Japanese Laid-Open Patent Publication No. 2005-039185
Patent Document 2: Japanese Laid-Open Patent Publication No. 2008-16000

### SUMMARY

According to one embodiment of the present disclosure, there is provided a gas supply method including: preparing a gas container filled with an easy-to-liquefy gas; and supplying the easy-to-liquefy gas from the gas container to a processing container in which a substrate process is performed using the easy-to-liquefy gas, via a gas supply path, wherein a pressure and a temperature of the easy-to-liquefy gas are controlled such that in the gas supply path, the pressure of the easy-to-liquefy gas decreases in a step-by-step manner and the temperature of the easy-to-liquefy gas increases from the gas container toward the processing container.

### BRIEF DESCRIPTION OF DRAWINGS

The accompanying drawings, which are incorporated in and constitute a part of the specification, illustrate embodiments of the present disclosure, and together with the general description given above and the detailed description of the embodiments given below, serve to explain the principles of the present disclosure.

FIG. 1 is a schematic configuration diagram showing an example of a gas processing facility using a gas supply method according to an embodiment.

FIG. 2 is a schematic configuration diagram showing an example of a gas supply system in the gas processing facility shown in FIG. 1.

FIG. 3 is a view showing a saturated vapor pressure curve of HF.

FIG. 4 is a view showing a detailed configuration of an internal pipe disposed in a cylinder cabinet.

FIGS. 5A to 5C are views for explaining a passivation process for a stainless steel (SUS316L) pipe.

### DETAILED DESCRIPTION

Reference will now be made in detail to various embodiments, examples of which are illustrated in the accompanying drawings. In the following detailed description, numerous specific details are set forth in order to provide a thorough understanding of the present disclosure. However, it will be apparent to one of ordinary skill in the art that the present disclosure may be practiced without these specific details. In other instances, well-known methods, procedures, systems, and components have not been described in detail so as not to unnecessarily obscure aspects of the various embodiments.

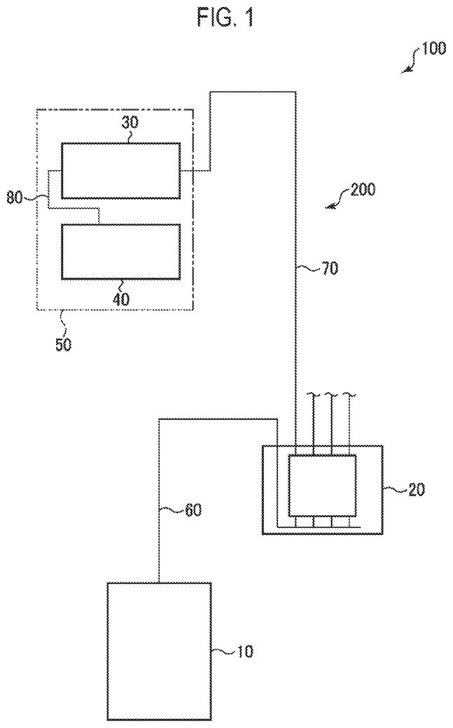

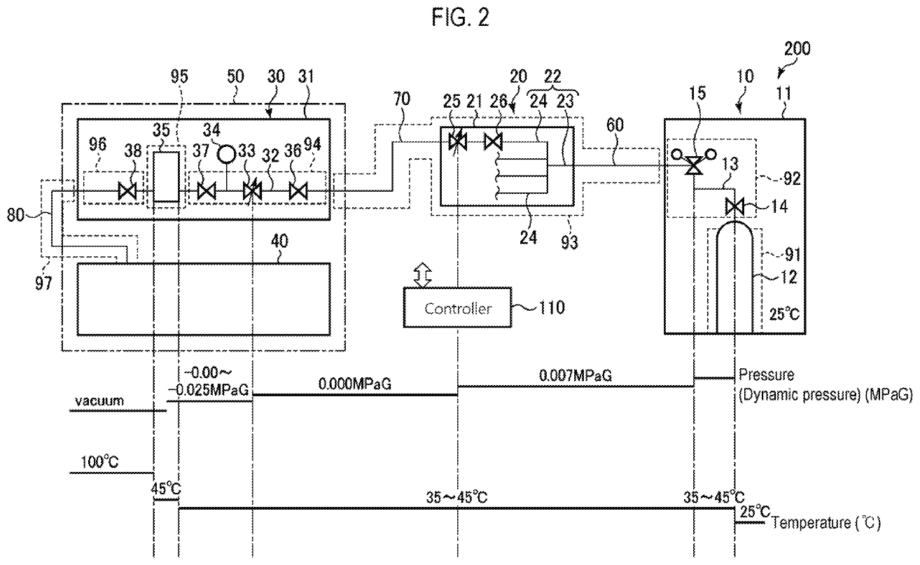

FIG. 1 is a schematic configuration diagram showing an example of a gas processing facility using a gas supply method according to an embodiment. FIG. 2 is a schematic configuration diagram showing an example of a gas supply system 200 in the gas processing facility shown in FIG. 1.

The gas processing facility 100 is configured to perform a process using an easy-to-liquefy gas, for example, an HF gas or a ClF₃ gas. The easy-to-liquefy gas referred to herein is, for example, a gas having a saturated vapor pressure of 100 kPa or less at room temperature (20 degrees C.). The gas processing facility 100 includes a cylinder cabinet 10 in which a cylinder as a gas container is accommodated, a VMB (Valve Manifold Box) 20 and a gas processing device 50. The gas processing device 50 includes a gas box 30 and a processing container (chamber) 40.

In a case where the gas processing device 50 is provided in plural numbers, the VMB 20 is provided to distribute a gas to individual devices. The VMB 20 may not be provided when there is one gas processing device 50. In some embodiments, even when there is a plurality of gas processing devices 50, a pipe may be merely branched without providing the VMB 20.

A pipe 60 as a gas flow path is provided between the cylinder in the cylinder cabinet 10 and the VMB 20. The VMB 20 is internally branched into a plurality of parts. A plurality of pipes 70 extends from the VMB 20. The other end of each pipe 70 is connected to the gas box 30 of the gas processing device 50. The gas box 30 and the processing container 40 are connected to each other by a pipe 80.

A combination of the cylinder cabinet 10, the VMB 20, the gas box 30 and the pipes 60, 70 and 80 constitutes the gas supply system 200.

As shown in FIG. 2, the cylinder cabinet 10 includes a housing 11, a cylinder 12 which is a gas container provided in the housing 11, and an internal pipe 13 for sending out a gas from the cylinder 12. The internal pipe 13 is provided with a valve 14 for sending out a vaporized gas from the cylinder 12 and a regulator 15 for regulating a pressure. Although not shown in FIG. 2, various devices described below are provided in the internal pipe 13 in addition to the regulator 15.

The VMB 20 includes a housing 21 and an internal pipe 22 provided in the housing 21. The internal pipe 22 includes a main pipe 23 connected to the pipe 60 and a plurality of branch pipes 24 branched from the main pipe 23. One ends of the pipes 70 are connected to the branch pipes 24. A regulator 25, a valve 26 and the like are provided in each of the branch pipes 24.

The gas box 30 includes a housing 31 and an internal pipe 32 provided in the housing 31. The internal pipe 32 is provided so as to penetrate the housing 31. One end of the internal pipe 32 is connected to the other end of the pipe 70. The other end of the internal pipe 32 is connected to one end of the pipe 80. A regulator 33, a pressure indicator 34 and a flow rate controller 35 such as a mass flow controller or the like are provided in the internal pipe 32 sequentially from the upstream side. Opening/closing valves 36, 37 and 38 are provided on the upstream side of the regulator 33, between the flow rate indicator 34 and the flow rate controller 35, and on the downstream side of the flow rate controller 35, respectively.

The processing container 40 is configured to perform a predetermined process, for example, etching of a silicon-based film, such as the above-described COR process or the like, on a substrate as a workpiece, for example, a semiconductor substrate, using an easy-to-liquefy gas, for example, an HF gas. A shower head (not shown) for supplying a gas in the form of a shower to a workpiece mounted on a stage (not shown) inside the processing container 40 is provided in an upper portion of the processing container 40. The other end of the pipe 80 is connected to the shower head.

The pressure of the supplied gas may be adjusted by the regulators 15, 25 and 33. When the gas flow rate is controlled by the flow rate controller 35, a change in pressure depending on the gas flow rate occurs in the flow rate controller 35. The pressure of the gas at this time is adjusted into a dynamic pressure by allowing a gas to flow to the processing container 40 at a usable maximum flow rate and operating the regulators.

As shown in FIG. 2, the gas pressure is controlled so as to decrease in a step-by-step manner from the gas pressure at the time of sending out the gas from the cylinder 12 of the cylinder cabinet 10 to the gas pressure at the time of supplying the gas to the processing container 40. At this time, a higher pressure on the outlet side of the cylinder 12 is preferable for stable gas supply. However, if there is a large pressure fluctuation at an orifice of the regulator, the gas is likely to be liquefied by adiabatic expansion. Thus, it is preferred that the pressure difference is reduced as far as possible

In this example, a gauge pressure from the regulator 15 to the regulator 25 is 0.007 MPaG. A gauge pressure from the regulator 25 to the regulator 33 is 0.00 MPaG (atmospheric pressure). A gauge pressure from the regulator 33 to the flow rate controller 35 is −0.00 to −0.0257 MPaG. Furthermore, parts following the flow rate controller 35 are kept at a vacuum.

However, the pressure control shown in FIG. 2 is merely an example. The pressure may be finely controlled by increasing the number of regulators. When the VMB 20 is not used, the pressures in the regulators 15 to 33 may be the same. In addition, the numerical values of the pressures are also merely an example.

A plurality of heater units capable of independently controlling a temperature is provided between the cylinder 12 and the pipe 80. The heater units control the gas temperature in the gas supply path extending from the cylinder 12 to the processing container 40 so that the gas temperature increases from the cylinder 12 toward the processing container 40. The temperature control is also performed by a controller 110.

For example, as shown in FIG. 2, the heater units include a first heater unit 91, a second heater unit 92, a third heater unit 93, a fourth heater unit 94, a fifth heater unit 95, a sixth heater unit 96 and a seventh heater unit 97. The first heater unit 91 heats the cylinder 12. The second heater unit 92 heats the internal pipe 13 in the cylinder cabinet 10. The third heater unit heats the pipe 60, the VMB 20 and the pipe 70. The fourth heater unit 94 heats a front stage portion of the internal pipe 32 of the gas box 30 up to just before the flow rate controller 35. The fifth heater unit 95 heats the flow rate controller 35. The sixth heater unit 96 heats a rear stage portion of the internal pipe 32 of the gas box 30 beyond the flow rate controller 35. The seventh heater unit 97 heats the pipe 80.

In this example, the internal temperature of the cylinder cabinet 10 is set to 25 degrees C. the temperature from the cylinder 12 to a portion immediately before the flow rate controller 35 of the gas box 30 is set to 35 to 45 degrees C., the temperature of the flow rate controller 35 is set to 45 degrees C., and the temperature on the downstream side of the flow rate controller 35 is set to 100 degrees C. However, the temperature control shown in FIG. 2 is merely an example. For example, in the example of FIG. 2, there is shown the case where the first to seventh heater units 91 to 97 are provided and the number of heating regions is seven. However, the number of heating regions is not limited thereto, and may be more than or less than seven. In addition, the numerical values of the temperature are also an example.

The pressure and the temperature at the time of supplying the gas are set such that the gas filled as a liquid in the cylinder 12 can be vaporized and then supplied to the processing container 40 at a sufficient flow rate without re-liquefaction. The pressure and temperature of the gas are determined based on a saturated vapor pressure curve of the gas. When the gas is re-liquefied, there is a risk of damaging the pipes and various devices. In particular, the HF gas and the ClF₃ gas are corrosive gases, and there is a risk that the liquefaction of the HF gas and the ClF₃ gas may cause corrosion of the pipes and various devices.

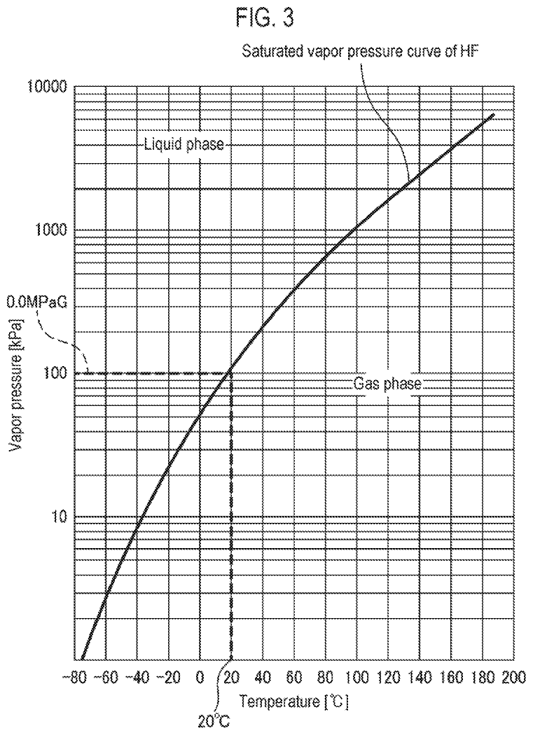

For example, the saturated vapor pressure curve of the HF gas is as show n in FIG. 3, and the temperature and pressure are set to be below the saturated vapor pressure curve. As described above, in the regulator, the pressure of the gas suddenly drops at a throttle portion. Then, the gas adiabatically expands so that the temperature thereof is likely to decrease. Therefore, the gas is likely to be locally liquefied. For this reason, the regulator sets the pressure and the temperature with sufficient margins from the vapor pressure curve. From such a viewpoint, as described above, the pressure and temperature of the gas are controlled so that in the gas supply path extending from the cylinder 12 to the processing container 40, the gas pressure decreases in a step-by-step manner and the gas temperature increases from the cylinder 12 toward the processing container 40.

In addition, it is preferable that the pipe making contact with an easy-to-liquefy gas such as a HF gas or the like is constructed with a heater and a heat insulating material to further suppress liquefaction of the easy-to-liquefy gas. In particular, it is preferable that the regulator is strictly constructed with a heater and a heat insulating material to prevent the gas from being cooled down by the pressure change.

In the present embodiment, in addition to taking the measures to prevent the gas liquefaction as described above, it is preferable not to supply impurities to the processing container as far as possible because the HF gas and the ClF₃ gas are corrosive gases. For this purpose, the following measures may be taken in the present embodiment.
(1) Stainless steel with fewer impurities is used as the stainless steel used for the pipes.
(2) High-purity gases are used as the gases.
(3) Since the HF gas or the like may react violently with moisture and may cause corrosion of the pipes and various devices, sufficient N₂-based purging and cycle purging are performed on the gas pipes and various devices before sending out the gases.
(4) An initial gas is discarded when sending out the gases.
(5) Passivation of the pipes is performed to suppress the generation of a contamination gas.

In (1) above, stainless steel containing fewer impurities is used for the pipes. It is preferable to use stainless steel in which the contents of Mn and Cu contained as impurities are 0.05 mass % or less and 0.20 mass % or less, respectively. SUS316L is preferred. If the content of Mn exceeds 0.5 mass %, corrosion near a welded portion is recognized. When the content of Cu exceeds 0.20 mass %, the semiconductor device as a workpiece is adversely affected. The content of Cu is preferably kept low, more preferably 0.10 mass % or less. For stainless steel having fewer impurities, it is preferable to use a double melt material obtained by performing vacuum melting twice. The basic composition of the SUS316L double melt material is preferably as follows: Ni: 14.00 to 15.00 mass %, Cr: 17.00 to 18.00 mass %, Mo: 2.50 to 3.00 mass %, C: 0.010 mass % or less, Si: 0.15 mass % or less, P: 0.020 mass % or less. S: 0.002 mass % or less, Al: 0.01 mass % or less, N: 0.0015 mass % or less, O: 0.0020 mass % or less, H: 0.0005 mass % or less, Fe and unavoidable impurities as the balance. For the pipes, it is preferable to use pipes whose gas flow surfaces are electrolytically polished to have a surface roughness Ry of 0.7 μm or less.

In (2) above, if impurities are contained in the easy-to-liquefy gas, they may cause corrosion of the pipes, clogging of the shower head, and the like. For example, in the case of the HF gas, it is preferable to use an HF gas having an extremely high purity of 99.999 mass % or more and containing, as impurities, 1 ppm or less of H₂SiF₆ and 5 ppm or less of H₂O in terms of mass. If the Si content is high, it may cause clogging of the shower head inside the processing container. If the H₂O content is high, it may cause corrosion. In the case of the ClF₃ gas, it is preferable to use a ClF₃ gas having a purity of 99.9 mass %.

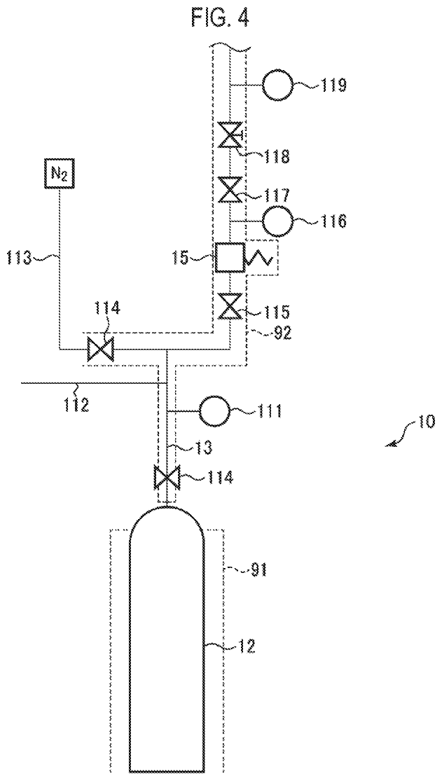

FIG. 4 shows a detailed configuration of the internal pipe of the cylinder cabinet 10 used for performing (3) above. A first pressure indicator 111, an exhaust line 112 and a purge line 113 are provided in the internal pipe 13 of the cylinder cabinet 10 in addition to the valve 14 and the regulator 15. A valve 115 is provided on the upstream side of the regulator 15 in the internal pipe 13. A second pressure indicator 116, a valve 117, an adjustment valve 118 and a third pressure indicator 119 are sequentially provided on the downstream side of the regulator 15 in the internal pipe 13.

Since the pipes cannot be sufficiently dried down by merely performing evacuation from the apparatus, the N₂ gas-based purging of the gas supply path is performed by supplying an N₂ gas from the purge line 113 to the gas supply path extending to the processing container 40 including the internal pipe 13. At the time of cylinder replacement, a cycle purging is performed in which the exhaust is purged using an exhaust line 112 and the N₂-based purging using the purge line 113 are alternately performed. The transition of the pressure in the internal pipe 13 can be seen on the first pressure indicator 111, the second pressure indicator 116 and the third pressure indicator 119.

Regarding (4) above, the gas initially discharged from the cylinder 12 contains a large amount of Si component and the like due to the influence of silica polishing of the inner wall of the cylinder 12, which may cause trouble. Therefore, it is preferable that the initial gas is discarded via the exhaust line 112 or the like, for example, at a flow rate of 1 slm for about 5 hours.

When the gas is discharged from the cylinder 12, it is preferable that the pipe extending to the gas box is not filled with the gas at once. If the volume of the pipe is larger than that of the gas in the cylinder 12, vaporization may not be caught up and a liquid may be sucked up. For this reason, it is preferable to open the valve 14 gradually instead of opening the valve 14 all at once.

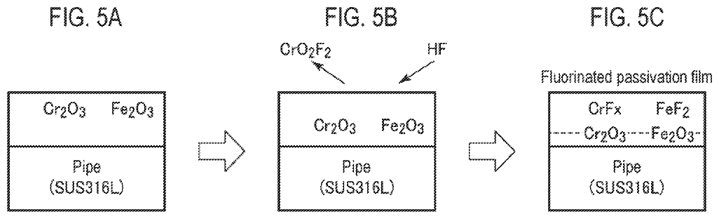

Regarding (5) above, a natural oxide film (Cr₂O₃ or Fe₂O₃) having a thickness of about several nm is formed on the surface of the pipe made of stainless steel (SUS316L) (FIG. 5A). When oxygen in the oxide film reacts with the HF gas, a contaminant gas having a high vapor pressure such as CrO₂F₂ or the like is generated (FIG. 5B). Thus, a passivation process of allowing the HF gas to flow through the pipe is performed for 10 hours or more, for example 14 hours, after discharging the gas to form a fluorinated passivation film such as CrFx or FeF₂ on the surface of the pipe (FIG. 5C). This makes it possible to suppress generation of contamination gas in the actual process.

According to the present embodiment, the easy-to-liquefy gas such as an HF gas or a ClF₃ gas is supplied from the cylinder 12, which is a gas container, to the processing container 40 via the gas supply path. At this time, the pressure and temperature of the gas are controlled such that in the gas supply path, the pressure of the gas decreases in a step-by-step manner and the temperature of the gas increases from the cylinder 12 toward the processing container 40.

Thus, it is possible to effectively suppress liquefaction of the gas in the middle of the gas supply path. At this time, the pressure and temperature of the gas have a sufficient margin with respect to the saturated vapor pressure curve, which makes it possible to ensure that the gas is hardly liquefied especially at the orifice portion of the regulator where the gas rapidly adiabatically expands.

In the related art, the process using an HF gas is disclosed in Patent Documents 1 and 2. However, these Patent Documents 1 and 2 do not teach how to supply an easy-to-liquefy gas such as an HF gas or the like.

Thus, in the present embodiment, in order to supply the easy-to-liquefy gas without re-liquefaction, the pressure and temperature of the gas are controlled such that the pressure of the gas decreases in a step-by-step manner and the temperature of the gas increases from the cylinder 12 toward the processing container 40.

The gas supply system of the above-described embodiment is merely an example. The gas supply system may be any gas supply system that supplies an easy-to-liquefy gas by reducing the pressure from an atmospheric pressure to a vacuum state.

Furthermore, in the above-described embodiment, the HF gas and the ClF₃ gas are exemplified as the easy-to-liquefy gas. However, the easy-to-liquefy gas is not limited thereto, and may be a TiCl₄ gas, an H₂O gas (water vapor) or the like.

According to the present disclosure in some embodiments, it is possible to provide a gas supply method and a gas supply system capable of supplying an easy-to-liquefy gas from a gas source to a processing container while suppressing liquefaction as far as possible.

Although the embodiment has been described above, it should be noted that the embodiment disclosed herein is illustrative and not restrictive in all respects. The above-described embodiment may be omitted, replaced or modified in various forms without departing from the scope and spirit of the appended claims.

What is claimed is:

1. A gas supply method comprising:
preparing a gas container filled with an easy-to-liquefy gas; and
supplying the easy-to-liquefy gas from the gas container to a processing container in which a substrate process is performed using the easy-to-liquefy gas, via a gas supply path,
wherein a pressure and a temperature of the easy-to-liquefy gas are controlled such that in the gas supply path, the pressure of the easy-to-liquefy gas decreases in a step-by-step manner and the temperature of the easy-to-liquefy gas increases from the gas container toward the processing container.

2. The method of claim 1, wherein the pressure and the temperature of the easy-to-liquefy gas are controlled based on a saturated vapor pressure curve of the easy-to-liquefy gas.

3. The method of claim 2, wherein the temperature of the easy-to-liquefy gas is increased by dividing a region from the gas container to the processing container into a plurality of heating regions and heating each of the plurality of heating regions with a heater unit.

4. The method of claim 3, wherein the pressure of the easy-to-liquefy gas is adjusted by a regulator.

5. The method of claim 4, wherein the pressure and the temperature of the easy-to-liquefy gas are controlled such that even when the easy-to-liquefy gas is cooled down by an adiabatic expansion caused by the regulator, a relationship between the pressure and the temperature is on a lower side of a saturated vapor pressure curve.

6. The method of claim 5, wherein the easy-to-liquefy gas is a gas having a saturated vapor pressure of 100 kPa or less at a room temperature of 20 degrees C.

7. The method of claim 6, wherein the easy-to-liquefy gas is an HF gas or a ClF₃ gas.

8. The method of claim 1, wherein the temperature of the easy-to-liquefy gas is increased by dividing a region from the gas container to the processing container into a plurality of heating regions and heating each of the plurality of heating regions with a heater unit.

9. The method of claim 1, wherein the pressure of the easy-to-liquefy gas is adjusted by a regulator.

10. The method of claim 1, wherein the easy-to-liquefy gas is a gas having a saturated vapor pressure of 100 kPa or less at a room temperature of 20 degrees C.

11. A gas supply system comprising:
a gas container filled with an easy-to-liquefy gas;
a gas supply path through which the easy-to-liquefy gas is supplied from the gas container to a processing container in which a substrate process is performed using the easy-to-liquefy gas;
a plurality of regulators provided in the gas supply path,
a plurality of heater units configured to heat a plurality of heating regions obtained by dividing the gas container and the gas supply path into plural regions;
a controller configured to control the plurality of regulators and the plurality of heater units such that in the gas supply path, a pressure of the easy-to-liquefy gas decreases in a step-by-step manner and a temperature of the easy-to-liquefy gas increases from the gas container toward the processing container.

12. The system of claim 11, wherein the controller controls the pressure and the temperature of the easy-to-liquefy gas based on a saturated vapor pressure curve of the easy-to-liquefy gas.

13. The system of claim 12, wherein the controller controls the pressure and temperature of the easy-to-liquefy gas such that even when the easy-to-liquefy gas is cooled down by an adiabatic expansion caused by the plurality of regulators, a relationship between the pressure and the temperature is on a lower side of the saturated vapor pressure curve.

14. The system of claim 13, wherein the easy-to-liquefy gas is a gas having a saturated vapor pressure of 100 kPa or less at a room temperature of 20 degrees C.

15. The system of claim 14, wherein the easy-to-liquefy gas is an HF gas or a ClF₃ gas.

16. The system of claim 1, wherein the easy-to-liquefy gas is a gas having a saturated vapor pressure of 100 kPa or less at a room temperature of 20 degrees C.
